(19) United States
(12) Patent Application Publication
(10) Pub. No.: US 2005/0210483 A1
(43) Pub. Date: Sep. 22, 2005

(54) Disk tray and optical disk apparatus having disk tray

(75) Inventor: Yosuke Amitani, Saitama (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 11/083,087

(22) Filed: Mar. 18, 2005

(30) Foreign Application Priority Data
Mar. 19, 2004 (JP) P 2004-081167
Mar. 16, 2005 (JP) P 2005-074919

(51) Int. Cl. G11B 17/04

(52) U.S. Cl. 720/619

(57) ABSTRACT

An optical disk apparatus having a disk tray includes a large-diameter disk placing portion (a first disk placing portion having a first disk placed thereon) and a small-diameter disk placing portion (a second disk placing portion having a second disk having a diameter smaller than that of the first disk placed thereon) A peripheral wall of the small-diameter disk placing portion is provided with an elastically deformable claw for holding the small-diameter disk 16.

### BACKGROUND OF THE INVENTION

1. Field of the invention

The present invention relates to a disk tray and an optical disk apparatus having the disk tray.

2. Description of the Related Art

Conventionally, disk transfer devices used for an optical disk apparatus have been known. These disk transfer devices are constructed such that an opening for entrance and exit of a disk tray is provided in a front panel of equipment which uses a disk, and after the disk is placed on the disk tray which comes out of the opening, the tray having the disk placed thereon is automatically drawn into a predetermined position (a position where the disk tray is loaded onto and unloaded from a turntable) in the apparatus.

In this type of disk apparatus, for instance, when reproduction is performed on the disk on the tray drawn into the apparatus while the disk is rotated at a predetermined revolution speed in a state of being loaded onto the turntable and pinched by a clamper, information signals recorded on the disk is reproduced by a reproducing and recording device.

In other words, a pickup for reading signals is moved according to track positions of signals recorded in a predetermined range on the disk, thereby reproducing the information signals.

Meanwhile, commercially available disks include, for example, large-diameter disks whose nominal diameter is 12 cm, and small-diameter disks whose nominal diameter is 8 cm. Accordingly, disk apparatuses which can cover any size of disks without troubles are generally required.

Therefore, in disk apparatuses of horizontal arrangement type, a large-diameter supporting portion supporting a large-diameter disk and a small-diameter disk supporting a small-diameter disk are provided in a disk tray, the small-diameter supporting portion is stepped so as to be located nearer to a turntable than the large-diameter disk supporting portion, and both the two supporting portions are used appropriately according to the size of a disk.

However, when the disk apparatuses are used in a posture in which they are vertically arranged, there is problems in that it is difficult to hold the small-diameter disk in the tray while being inclined above a certain degree of angle from the horizontal direction, and in addition, it is difficult to return the disk sandwiched between the turntable and clamper by a magnetic force to the small-diameter supporting portion.

Disk trays for solving the above problems are suggested (for instance, see JP-A-8-335352, JP-A-2003-257112).

The disk tray disclosed in JP-A-8-335352 comprises three auxiliary guides. Each of the auxiliary guides is adapted to be slidable between a position which does not protrude from the surface of a concave guide portion and a position which protrudes from the surface of the concave guide portion.

According to the above disk tray, when the tip of an operating lever is rotated in using a small-diameter disk, each of the auxiliary guides connected by a connecting portion rotates and the tip of each of the auxiliary guides rides on an inclined surface of a receiving window and then protrudes to the concave guide portion.

In this state, the small-diameter disk is placed inside the respective auxiliary guides, and the small-diameter disk is held in the middle of a main body of the disk tray by the respective auxiliary guides.

In the disk apparatus 1 disclosed in JP-A-2003-257112, as shown in FIG. 1, a small-diameter supporting portion 2 is formed with a predetermined amount of a step so as to be located nearer to a turntable than the large-diameter supporting portion 3. Locking claws 5 are formed on the outer peripheral portion of the small-diameter supporting portion 2 so that they can lock a lower outer peripheral edge of the small-diameter disk 4 in supporting the small-diameter disk 4, even when a disk apparatus 1 is arranged to incline above a predetermined range of angles from the horizontal direction.

Each claw 5 is provided in the range of being located in the lower portion of the disk apparatus 1 vertically arranged.

Further, each claw 5 has inclined portions 5A and 5B on both sides thereof. When the outer peripheral edge of the small-diameter disk 4 rides over the locking claws 5, the disk rides over the locking claws along the inclined portions 5A and 5B, thereby helping the riding-over movement.

As shown in FIG. 2A, the damper 6 and the turntable 7 are separated from each other above a certain degree. The small-diameter disk 4 falls toward a lower end of the small-diameter supporting portion 2 of a main tray 8, and its outer peripheral edge is locked by the locking claws 5. In this state, a center hole 4A of the small-diameter disk 4 is made eccentric downward by a predetermined distance.

As shown in FIG. 2B, when the turntable 7 approaches the damper 6, a tapered portion 7A of the turntable 7 is engaged with the center hole 4A, to lift the small-diameter disk 4 along its inclined portion.

At this time, a magnetic force is exerted between a magnet and the turntable 7 to draw the damper 6 toward the turntable 7, that is, in a direction indicated by an arrow, and to sandwich the small-diameter disk 4 therebetween.

As shown in FIG. 2C, as the turntable 7 further moves toward the damper 6, the small-diameter disk 4 moves toward the damper 6 while outer peripheral edge of its lower portion rides over the locking claws 5. At this time, the outer peripheral edge of the lower portion in the small-diameter disk 4 rides over the locking claws 5 along the inclined portion 5A (see FIG. 1).

### SUMMARY OF THE INVENTION

The conventional disk tray (for instance, the disk tray in JP-A-8-33583) has a problem in that it is necessary to construct the three auxiliary guides in such a manner to be slidable between the position which does not protrude from the surface of the concave guide portion and the position which protrudes from the surface of the concave guide portion, which results in a complicated structure.

Since the conventional apparatus (for instance, the disk appratus in JP-A-2003-257112) has a structure in which only the lower portion of the small-diameter disk 4 is supported by the respective locking claws 5, it is difficult to firmly support the small-diameter disk 4.

Therefore, there is a problem in that the probability of falling of the small-diameter disk 4 is high.

Accordingly, an object of the present invention is to solve the problems caused in the above-mentioned related art, such as, for example, the problem that the structure of a disk tray becomes complicated because the auxiliary guides are constructed in such a manner to be slidable between the position which does not protrude from the surface of the concave guide portion and the position which protrudes from the surface of the concave guide portion, and the problem that the probability of falling of a small-diameter disk is high because only the lower portion of the small-diameter disk is supported by the locking claws.

According to a first aspect of the invention, a disk tray includes: a first disk placing portion having a first disk placed thereon; a second disk placing portion having a second disk having a diameter smaller than that of the first disk placed thereon; and an elastically deformable claw for holding the second disk, provided at a peripheral wall of the second disk placing portion.

According to a second aspect of the invention, a disk apparatus comprises a disk tray, in which the disk tray includes: a first disk placing portion having a first disk placed thereon; a second disk placing portion having a second disk having a diameter smaller than that of the first disk placed thereon; and an elastically deformable claw for holding the second disk, provided at a peripheral wall of the second disk placing portion.

### BRIEF DESCRIPTION OF THE DRAWINGS

FIG. 1 is a cross-sectional view of a conventional disk tray.

FIGS. 2A to 2B show a state in which a small-diameter disk is clamped by the conventional disk tray.

FIG. 3 is a perspective view of an optical disk apparatus according to an embodiment of the present invention.

FIG. 4 is a plan view of a disk tray according to the embodiment of the present invention.

FIG. 5 is a cross-sectional view of the disk tray according to the embodiment of the present invention.

FIG. 6 is a cross-sectional view showing another example of the disk tray according to the embodiment of the present invention.

FIGS. 7A to 7E show a first method of placing and driving the small-diameter disk on the optical disk apparatus according to the embodiment of the present invention, and then removing the disk.

FIGS. 8A to 8D show a second method of placing and driving the small-diameter disk on the optical disk apparatus according to the embodiment of the present invention, and then removing the disk.

FIG. 9 is a cross-sectional view showing a first modification of the disk tray according to the embodiment of the present invention.

FIG. 10 is a perspective view showing a second modification of the disk tray according to the embodiment of the present invention.

FIG. 11 is a cross-sectional view taken along the line C-C in FIG. 10.

FIG. 12 is a cross-sectional view showing a third modification of the disk tray according to the embodiment of the present invention.

FIGS. 13A to 13D are views for explaining the features of the third modification of the disk tray according to the embodiment of the present invention.

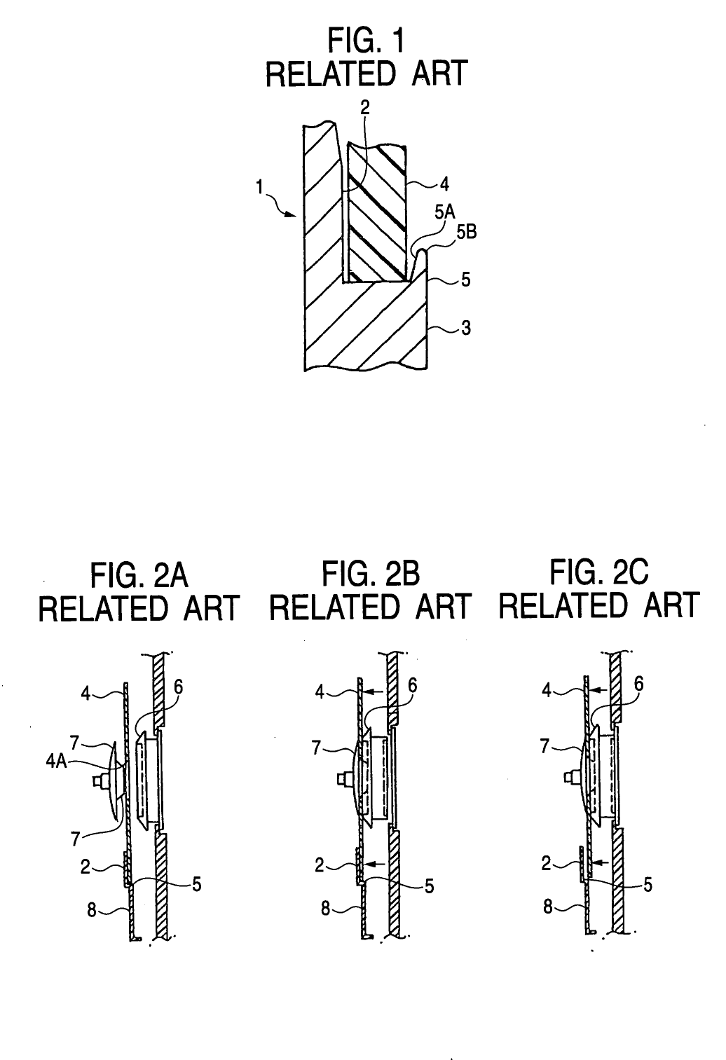

### DETAILED DESCRIPTION OF THE PREFERRED EMBODIMENTS

Hereinafter, an embodiment of a disk tray and an optical disk apparatus having a disk tray according to the present invention will be described with reference to the accompanying drawings.

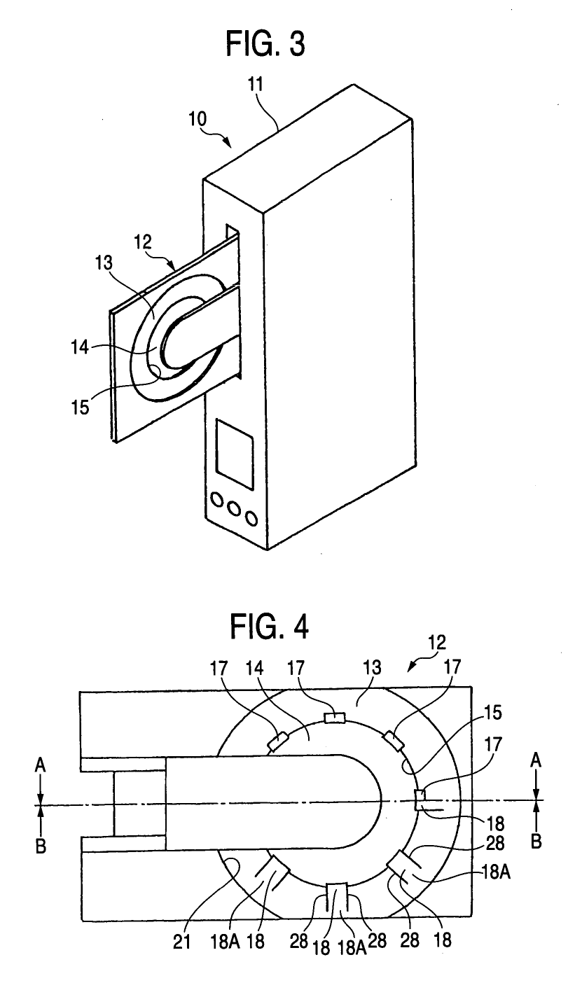

FIGS. 3 to 6 show the structure of main parts of the optical disk apparatus having the disk tray according to the embodiment of the present invention.

In addition, although the present embodiment will be described about a horizontal arrangement of the disk tray in order to facilitate understanding of the present invention, the same effects can also be obtained by a vertical arrangement of the disk tray.

An optical disk apparatus 10 according to the present embodiment is an optical disk player, an optical disk recorder, or the like, which uses an optical disk, such as a compact dick (CD) or digital versatile disk (DVD), as an information recording medium, and its example is shown in FIG. 3. A disk drive (not shown) with a mechanism which drives the optical disk is provided in a case 11 of the optical disk apparatus 10 in FIG. 3, and a disk tray 12 is also incorporated into the case.

The disk tray 12 comprises a large-diameter disk placing portion 13, and a small-diameter disk placing portion 14 arranged inside and coaxially with the large-diameter disk placing portion 13.

The large-diameter disk placing portion 13 is a portion which supports a large-diameter disk (its nominal diameter is 12 cm), and the small-diameter disk placing portion 14 is a portion which supports a small-diameter disk (its nominal diameter is 8 cm).

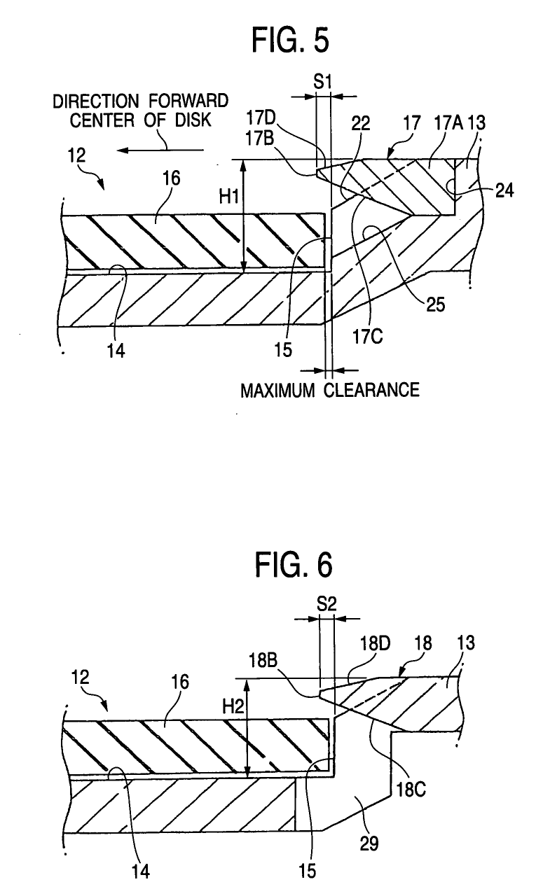

In the disk tray 12 shown in FIG. 4, the small-diameter disk placing portion 14 is concavely formed inside the large-diameter disk placing portion 13, and elastically deformable claws 17 or 18 for holding the small-diameter disk 16 (see FIG. 5) are provided on a peripheral wall 15 of the small-diameter disk placing portion 14.

The large-diameter disk placing portion 13 is a concave portion which is formed so as to receive the large-diameter disk with its peripheral wall 21 slightly larger than the outer circumference of the large-diameter disk.

The small-diameter disk placing portion 14 is a concave portion which is formed inside the large-diameter disk placing portion 13 so as to receive the small-diameter disk 16 with the peripheral wall 15 slightly larger than the small-diameter disk 16.

The deformable claws 17 or 18 are projections which extend radially inwardly toward the middle of the small-diameter disk placing portion 14 from the peripheral wall 15 of the small-diameter disk placing portion 15, and which is elastically deformable for holding the small-diameter disk 16 in the small-diameter disk placing portion 14.

It is noted herein that the deformable claws 17 are formed of a member different from the disk tray 12. These deformable claws 17 will be described referring to FIG. 5.

Further, the deformable claws 18 are integrally formed with the disk tray 12, and these deformable claws 18 will be described referring to FIG. 6.

As shown in FIG. 5, the small-diameter disk placing portion 14 is concavely formed at a position having a depth H1 with respect to the large-diameter disk placing portion 13, and the peripheral wall 15 of the small-diameter disk placing portion 14 is formed to be slightly larger than the outer circumference of the small-diameter disk 16.

An inclined portion 22 is formed to incline downward toward the peripheral wall 15 of the small-diameter disk placing portion 14 from the large-diameter disk placing portion 13. A receiving concave portion 24 which receives a base 17A of each deformable claw 17 is formed in the large-diameter disk placing portion 13, and a relief groove 25 is formed in the inclined portion 22 continuously with the receiving concave portion 24.

Moreover, an inclined relief surface 17C is formed inside the deformable claw 17 so as to incline upward toward the tip 17B from the base 17A of the deformable claw 17. This allows the inclined relief surface 17C to escape into the relief groove 25 when the deformable claw 17 is elastically deformed toward the small-diameter disk placing portion 14, thereby preventing the deformable claw 17 from interfering with the disk tray 12.

In addition, the inclined relief surface 17C is formed inside the deformable claw 17, to prevent the interference between the small-diameter disk 16 and the deformable claw 17 when the small-diameter disk 16 is set in the small-diameter disk placing portion 14.

Further, an inclined guide surface 17D with downward inclination can be formed outside the tip of the deformable claw 17, to place an outer peripheral portion of the small-diameter disk 16 well on the inclined guide surface 17D. Accordingly, the deformable claw 17 can be well elastically deformed downward by the deformable claw 16 to easily set the small-diameter disk 16 in the small-diameter disk placing portion 14.

Here, the dimension of a distance S1 from the peripheral wall 15 of the small-diameter disk placing portion 14 to the tip 17B of the deformable claw 17, the dimension of the depth H1 of the small-diameter disk placing portion 14, and the shape of the relief groove 25 and the inclined relief surface 17C are set such that the deformable claw 17 can be elastically deformed to smoothly set the small-diameter disk 16 in the small-diameter disk placing portion 14, and the deformable claw 17 can be returned to its original position after the small-diameter disk 16 has been set in the small-diameter disk placing portion 14.

Next, the deformable claw 18 integrally formed with the disk tray 12 will be described referring to FIG. 6. In addition, the same members in FIG. 6 as those in FIG. 5 are denoted by the same reference numerals, and the description thereof will be omitted.

As shown in FIG. 6, the small-diameter disk placing portion 14 is formed at a position having a depth H2 with respect to the large-diameter disk placing portion 13, and the peripheral wall 15 of the small-diameter disk placing portion 14 is formed to be slightly larger than the outer circumference of the small-diameter disk 16.

A slit 28 (see FIG. 4) is engraved on the large-diameter disk placing portion 13 to form each deformable claw 18 whose base 18A (see FIG. 4) can be elastically deformed. When the deformable claw 18 is elastically deformed toward the small-diameter disk placing portion 14, an opening 29 is formed so as to avoid the interference between the deformable claw 18 and the disk tray 12.

An inclined relief surface 18C is formed inside the deformable claw 18 so as to incline upward toward a tip 18B. This prevents the interference between the small-diameter disk 16 and the deformable claw 18 when the small-diameter disk 16 is set in the small-diameter disk placing portion 14.

Further, an inclined guide surface 18D with downward inclination can be formed outside the tip of the deformable claw 18, to place an outer peripheral portion of the small-diameter disk 16 well on the inclined guide surface 18D. Accordingly, the deformable claw 18 can be well elastically deformed downward to easily set the small-diameter disk 16 in the small-diameter disk placing portion 14.

Here, the dimension of a distance S2 from the peripheral wall 15 of the small-diameter disk placing portion 14 to the tip 18B of the deformable claw 18, the dimension of the depth H2 of the small-diameter disk placing portion 14, and the shape of the inclined relief surface 18C are set such that the deformable claw 18 can be elastically deformed to smoothly set the small-diameter disk 16 in the small-diameter disk placing portion 14, and the deformable claw 18 can be returned to its original position after the small-diameter disk 16 has been set in the small-diameter disk placing portion 14.

In addition, although FIG. 4 shows an example in which the elastically deformable claws 17 are provided at upper half-periphery of the peripheral wall 15 of the small-diameter disk placing portion 14, and the elastically deformable claws 18 are provided at the lower half-periphery 18 thereof, the deformable claws 17 can also be provided at the entire periphery of the peripheral wall 15 of the small-diameter disk placing portion 14, or the deformable claws 18 can also be provided at the entire periphery of the peripheral wall 15 of the small-diameter disk placing portion 14.

Moreover, fixing claws can be provided at one half-periphery of the peripheral wall 15 of the small-diameter disk placing portion 14, and deformable claws can be provided at the other half-periphery thereof, rather than providing the elastically deformable claws 17 and 18 at the entire periphery of the peripheral wall 15 of the small-diameter disk placing portion 14.

The two kinds of deformable claws and fixing claws can be employed to more firmly hold the small-diameter disk 16 in the small-diameter disk placing portion 14.

In addition, various kinds of claws can be selected according to their uses to further increase the freedom of design.

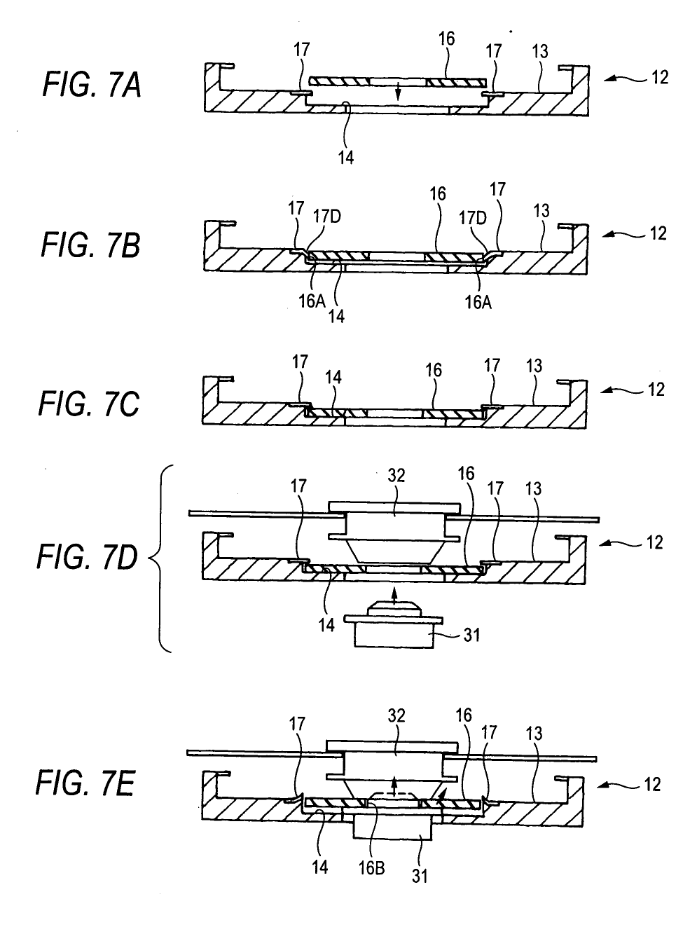

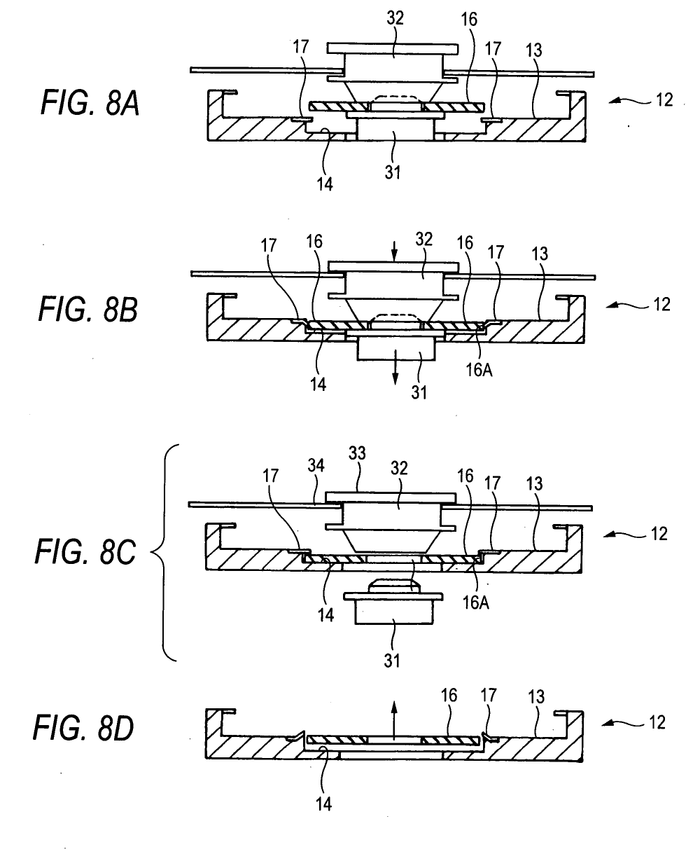

Next, an example in which the small-diameter disk 16 is set in a read/write state in the disk tray 12 of the optical disk apparatus according to the embodiment of the present invention, and after the completion of read/write, the small-diameter disk 16 is removed, will be described referring to FIG. 7 and FIG. 8.

First, in the case of setting the small-diameter disk 16, as shown in FIG. 7A, the small-diameter disk 16 is lowered from the upper side of the small-diameter disk placing portion 1 toward the small-diameter disk placing portion 14 in a direction indicated by an arrow.

As shown in FIG. 7B, the outer peripheral portion 16A of the small-diameter disk 16 is placed on the inclined guide surface 17D (also see FIG. 5) of each of the deformable claws 17, and the small-diameter disk 16 is further lowered from this state in the direction indicated by the arrow to elastically deform the deformable claws 17 downward seen from the viewpoint of FIG. 7B.

As shown in FIG. 7C, the small-diameter disk 16 is set in the small-diameter disk placing portion 14, and the deformable claws 17 return to their original positions from the elastically deformed state.

As shown in FIG. 7D, the disk tray 12 is closed to move a spindle 31 toward a damper 32, that is, in the direction indicated by the arrow.

As shown in FIG. 7E, the spindle 31 enters a mounting hole 16B of the small-diameter disk 16. Thereby, the mounting hole 16B of the small-diameter disk 16 is positioned toward the middle of the spindle 31 by a taper and a claw of the spindle 31.

The small-diameter disk 16 which has been pushed up by the spindle 31 pushes up the deformable claws 17, and gets outs from the small-diameter disk placing portion 14.

Thereafter, as shown in FIG. 8A, the small-diameter disk 16 which is being held by the damper 32 and the spindle 31 moves toward the small-diameter disk placing portion 14 with the movement of the spindle 31 toward the small-diameter disk placing portion 14, and the small-diameter disk 16 is held at its readable/writable position by a magnetic force between the spindle 31 and the damper 32.

The state shown in FIG. 8A is a state in which the disk can be read/written. In this state, the small-diameter disk 16 is driven by a disc drive (not shown).

Next, as shown in FIG. 8B, the deformable claws 17 is pushed down by the outer peripheral portion 16A of the small-diameter disk 16 prior to opening of the disk tray 12 after the completion of driving by the disc drive, and thereby the small-diameter disk 16 moves between the small-diameter disk placing portion 14 and the deformable claws 17.

Then, as shown in FIG. 8C, the holding of the small-diameter disk 16 is released.

Specifically, the method of releasing the holding of the small-diameter disk 16 in FIG. 8C will be described by taking first to third examples.

According to the first example, a collar 33 provided in the damper 32 comes into contact with a damper holding member 34 (clamper holder), thereby stopping the movement of the damper 32 and releasing the holding of the small-diameter disk 16.

According to the second example, the outer peripheral portion 16A of the small-diameter disk 16 comes into contact with the small-diameter disk placing portion 14, thereby stopping the movement of the small-diameter disk 16 and releasing the holding the small-diameter disk 16.

According to the third example, a force is exerted to the damper 32 in a direction away from the small-diameter disk placing portion 14 by means of a spring (not shown) or the like, and when this force exceeds the magnetic force, the holding of the small-diameter disk 16 is released.

Then, in the above state, the small-diameter disk 16 settled in the small-diameter disk placing portion 14 is transferred, along with the disk tray 12, to a position where the small-diameter disk 16 can be taken out.

Finally, as shown in FIG. 8D, the small-diameter disk 16 is removed.

As described above, when the small-diameter disk 16 is removed from the small-diameter disk placing portion 14, an operation reverse to the operation of placing the small-diameter disk 16 in the small-diameter disk placing portion 14 is performed.

As a result, the deformable claws 17 are elastically deformed, and the aperture of the small-diameter disk placing portion 14 increases, so that the small-diameter disk 16 can be removed from the small-diameter disk placing portion 14.

Meanwhile, when a large-diameter disk is placed and transferred after the holding of the small-diameter disk 16 has been released as in the first and second examples, the damper 32 remains at a position where it has released the holding of the small-diameter disk 16. Thus, during this transfer, the large-diameter disk comes into contact with the damper 32, but a tapered portion is provided at the tip of the damper 32, and the transferred large-diameter disk comes into contact with the tapered portion to push up the damper 32. As a result, the large-diameter disk can be prevented from being caught while being transferred.

In addition, the method of releasing the holding of a large-diameter disk may be performed according to the second example of the method of releasing the holding of small-diameter disk 16 by, for instance, releasing the holding of the disk at a point of time when the large-diameter disk is pushed against the large-diameter disk placing portion 13.

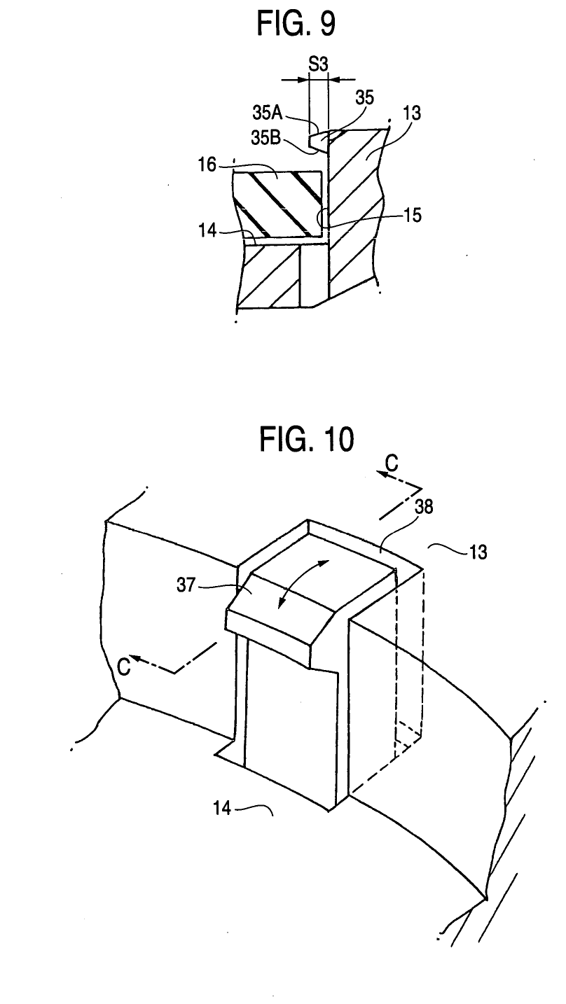

Next, a first to third modifications of the present embodiment will be described referring to FIG. 9 to FIG. 13.

In the first modification shown in FIG. 9, a deformable claw 35 is provided in an upper portion of the peripheral wall 15 of the small-diameter disk placing portion 14, and upper and lower inclined surfaces 35A and 35B are provided on the upper and lower surfaces of the deformable claw 35. The provision of the upper and lower inclined surfaces 35A and 35B allows the deformable claw 35 to be formed in a tapered shape.

The deformable claw 35 is provided in the upper portion of the peripheral wall 15 to suppress a protruding amount S3 of the deformable claw 35 as small as possible.

This makes it possible to suppress the amount of elastic deformation as small as possible. Also, when the small-diameter disk 16 is set in the small-diameter disk placing portion 14, the deformable claw 35 can be smoothly returned to its original position.

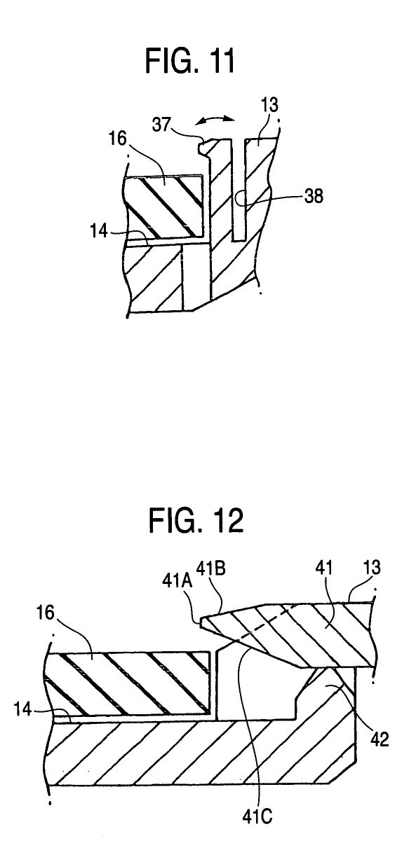

In the second modification shown in the perspective view of FIG. 10 and the cross-sectional view taken along the line C-C of FIG. 11, a deformable claw 37 is provided in an upper portion of the peripheral wall 15 of the small-diameter disk placing portion 14, and a slit 38 is provided outside the peripheral wall 15.

The provision of the slit 38 at the outside of the peripheral wall 15 allows elastic deformation of the deformable claw 37 in a direction indicated by an arrow, that is, in the horizontal direction.

As a result, when the small-diameter disk 16 is set in the small-diameter disk placing portion 14, the deformable claw 37 need not be elastically deformed toward the small-diameter disk placing portion 14. Thus, the deformable claw 37 can be more smoothly returned to its original position after the small-diameter disk 16 is set in the small-diameter disk placing portion 14.

In the third modification shown in FIG. 12, a supporting portion 42 is provided to abut a neighborhood of a tip 41A of the deformable claw 41, and an inclined guide surface 41B and an inclined relief surface 41C are respectively provided on the upper and lower surfaces of the deformable claw 41.

The provision of the inclined guide surface 41B outside the deformable claw 41 allows the outer peripheral portion of the small-diameter disk 16 to be well placed on the inclined guide surface 41B. Therefore, the deformable claw 41 can be well elastically deformed downward by the small-diameter disk 16, so that the small-diameter disk 16 can be set on the small-diameter disk placing portion 14.

Further, the provision of the inclined relief surface 41C inside the deformable claw 41 prevents the deformable claw 41 from interfering with the disk tray 12 when the deformable claw 41 is elastically deformed toward the small-diameter disk placing portion 14.

In addition, the inclined relief surface 41C is formed inside the deformable claw 41, thereby preventing interference between the small-diameter disk 16 and the deformable claw 41 when the small-diameter disk 16 is set in the small-diameter disk placing portion 14.

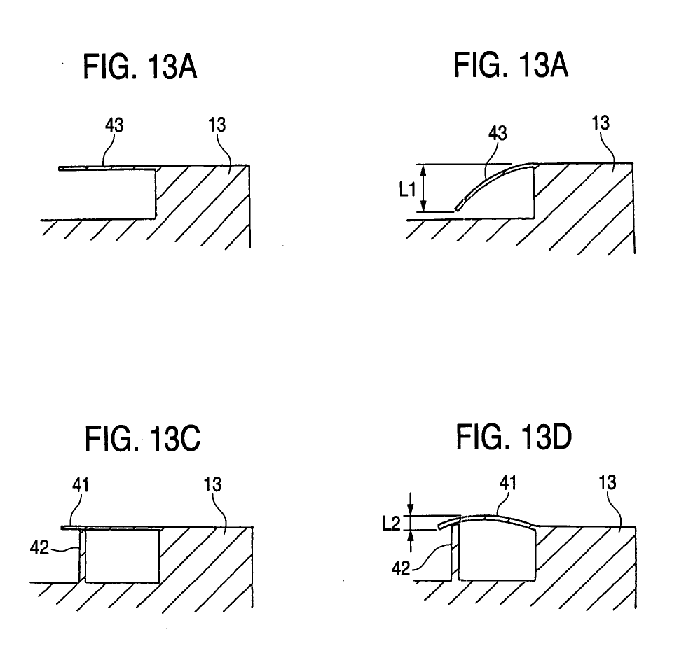

In addition, the reason why the supporting portion 42 is provided will now be described referring to FIG. 13.

FIGS. 13A and 13B show an example with no supporting portion 42, and FIGS. 13C and 13D shows an example with the supporting portion 42.

As shown in FIGS. 13A and 13B, since the supporting portion 42 is not provided, the amount of elastic deformation of the claw 43 is as large as L1.

As shown in FIGS. 13C and 13D, the supporting portion 42 supports the neighborhood of the tip 41A of the deformable claw 41. Therefore, the amount of elastic deformation of the claw 41 can be suppressed as small as L2.

As a result, since the amount of downward elastic deformation of the deformable claw 41 can be suppressed when the small-diameter disk 16 is set in the small-diameter disk 14, the deformable claw 41 can be more smoothly returned to its original position after the small-diameter disk 16 is set in the small-diameter disk placing portion 14.

As described above in detail, the optical disk apparatus 10 according to the present embodiment comprises a disk tray 12 including the large-diameter disk placing portion 13 (a first disk placing portion having a first disk placed thereon) and the small-diameter disk placing portion 14 (a second disk placing portion having a second disk having a diameter smaller than that of the first disk placed thereon), and the peripheral wall 15 of the small-diameter disk placing portion 14 is provided with the elastically deformable claws 17, 18, 35, 37, or 41 for holding the small-diameter disk 16.

As a result, the entire periphery of the small-diameter disk 16 can be supported by the deformable claw 17, 18, 35, 37 or 41, to firmly hold the small-diameter disk 16, thereby preventing the falling of the disk.

In addition, since the present invention employs only a structure having the elastically deformable claws 17, 18, 35, 37 or 41 on the peripheral wall 15 of the small-diameter disk placing portion 14, its structure can be simplified.

1. A disk tray comprising:
a first disk placing portion having a first disk placed thereon;
a second disk placing portion having a second disk having a diameter smaller than that of the first disk placed thereon; and
an elastically deformable claw for holding the second disk, provided at a peripheral wall of the second disk placing portion.

2. The disk tray according to claim 1, further comprising:
a fixing claw provided at a first half-periphery of the peripheral wall of the second disk placing portion,
wherein the deformable claw is provided at a half-periphery of the peripheral wall other than the first half-periphery.

3. The disk tray according to claim 1,
wherein a plurality of the deformable claws is provided at predetermined intervals.

4. The disk tray according to claims 1,
wherein the deformable claw is formed by providing a slit outside the peripheral wall of the second disk placing portion.

5. The disk tray according to claim 1,
wherein the deformable claw extends in a radial direction of the second disk placing portion, and a supporting portion which supports a tip of the deformable claw from the inner side of the second disk placing portion is provided.

6. The disk tray according to claim 1,
wherein an inclined guide surface that guides an outer peripheral portion of the second disk is provided outside the tip of the deformable claw.

7. The disk tray according to claim 1,
wherein an inclined relief surface that avoids the interference with the second disk is provided outside the tip of the deformable claw.

8. A disk apparatus comprising a disk tray, wherein the disk tray includes:
a first disk placing portion having a first disk placed thereon;
a second disk placing portion having a second disk having a diameter smaller than that of the first disk placed thereon; and
an elastically deformable claw for holding the second disk, provided at a peripheral wall of the second disk placing portion.
